(19) United States
(12) Patent Application Publication
(10) Pub. No.: US 2005/0097015 A1
(43) Pub. Date: May 5, 2005

(54) Electronic financial transactions with portable merchant accounts

(76) Inventors: W. Bradley Wilkes, Alpine, UT (US); Dan Roper, Provo, UT (US)

Correspondence Address: R. BURNS ISRAELSEN;WORKMAN NYDEGGER, 1000 Eagle Gate Tower, 60 East South Temple, Salt Lake City, UT, 84111, US

(21) Appl. No.: 10/697,374

(22) Filed: Oct. 30, 2003

(51) Int. Cl. G06F 17/60

(52) U.S. Cl. 705/30

(57) ABSTRACT

Methods of conducting an electronic financial transaction using ambiguous transaction devices. A merchant conducts a transaction with a payer using an ambiguous transaction device, such as a cellular phone. The ambiguous device transmits a transaction request, which includes transaction data and merchant identifying information, over a network to an acquiring bank. The ambiguous device generates the transaction request by accessing merchant identifying information that is stored separately from the ambiguous device in, for example, a stripe of a financial card or a SIM card. The merchant account of the merchant is portable in the sense that the merchant can use multiple ambiguous transaction devices to initiate transactions by causing the selected transaction device to have access to the separately stored merchant identifying information. The acquiring bank, upon receiving the transaction request, initiates authorization of the requested transaction and execution thereof.

### CROSS-REFERENCE TO RELATED APPLICATIONS

Not applicable.

### BACKGROUND OF THE INVENTION

1. The Field of the Invention

The present invention relates generally to electronic financial transactions. More specifically, the present invention relates to electronic financial transaction with portable merchant accounts.

2. The Relevant Technology

Electronic financial transactions have become commonplace among merchants and consumers. Electronic financial transactions have accelerated commerce by eliminating the need to carry cash or to provide exact change for purchases. In addition businesses conducting electronic transactions add value to their business by compiling data from the electronic transaction, such as tracking inventory and learning customer buying preferences.

Many electronic transactions occur using a financial card such as a credit card. Today, using a financial card in a transaction requires a person to establish a relationship with an issuer and become a cardholder. Becoming a cardholder is a process that is well known to a large number of people. Generally, a person completes a simple application and provides the completed application to the issuer. Once the issuer approves and delivers a financial card to the person, the cardholder can use the card to purchase goods and/or services from a merchant that accepts that particular card. Usually, the cardholder is given a line of credit that limits the amount of transactions that can be placed on the financial card during a given period.

To accept payment in an electronic financial transaction, a person must obtain a merchant account. The merchant applies for a merchant account with an acquirer bank. The acquirer bank has relationships with associations that process financial card transactions. When a merchant engages in a transaction, funds are transferred from the issuer bank to the acquirer bank and deposited in the merchant's merchant account.

In addition to establishing a merchant account, the merchant must also purchase a transaction device that will allow the merchant to transact and transmit the transaction to the acquirer. A point of sale terminal is a common transaction device used to perform electronic transactions. Each point of sale terminal is encoded with the merchant's account information, such as the merchant's name or a unique identification number. The point of sale terminal usually has several ways of entering in transaction data. Some data is entered in by keying numbers on a number pad, and other information is input through a card reader.

Many different point of sale terminals have been developed. Some point of sale terminals are incorporated into a cash register, others are stand-alone terminals such as the point of sale terminals commonly placed at checkout stands in retail stores and in grocery stores. Some point of sale terminals are wireless and battery operated such that they can be used at remote locations, such as a concession stand.

In a typical electronic transaction, the customer provides card information by swiping his or her financial card. The financial card has a magnetic strip encoded with transaction data, such as the card number and expiration date. Once the payer's information is input, the merchant enters an amount owed and sends a request for transaction approval and execution. As mentioned above, the merchant's account information is programmed into the point of sale device. The point of sale device automatically includes the stored merchant account information in the transmission.

While transactions conducted using a point of sale device are fast and convenient, establishing a merchant account, buying a point of sale terminal and configuring the point of sale terminal can be costly and time consuming. Existing point of sale devices work well for businesses that do large numbers of transactions using a single merchant account. In these cases, the time and expense of the point of sale terminal are spread out over large numbers of transaction.

Existing point of sale terminals are not as cost effective for other types of transactions. For instance, some businesses do large volumes of transactions, but they need a merchant account and a point of sale terminal for each of their sales representatives. Each sales representative does a low volume of transactions, even though the business does large numbers of transactions cumulatively. The cost of a point of sale terminal therefore is not spread out over as many transactions and can significantly increase the cost of doing business. If the business has a high turnover of sales representatives, reprogramming the point of sale devices can also be a significant burden.

Some point of sale terminals have the ability to be configured for multiple merchant accounts. For example, medical offices often use a point of sale terminal with multiple merchant accounts even though there is a single medical office. However, these devices require the individual merchants using the device to share the device in a single location. Businesses with sales representatives who conduct transactions off-site cannot benefit from these types of point of sale terminals.

In other instances existing point of sale devices are cost prohibitive. For instance, two individuals may want to conduct an electronic transaction, but purchasing and programming an existing point of sale terminal would not be warranted by the frequency and count of their transactions. Many individuals would prefer to conduct transactions electronically but instead must maintain a checking account or cash to make payment for items that cannot be paid for without a point of sale terminal.

As cash and check methods of payment continue to decrease, there is a need for a cost effective device and method that will allow individuals and businesses to easily engage in low volume electronic transactions.

### BRIEF SUMMARY OF THE INVENTION

The present invention facilitates electronic transactions and overcomes the problems with electronic transaction devices discussed above by providing an ambiguous transaction device and a portable merchant account. A merchant, such as an individual or a sales representative, can accept payment from another by establishing a portable merchant account and conducting the electronic transaction using the ambiguous transaction device.

The ambiguous transaction device is a network device that is capable of transmitting an electronic financial transaction. Merchant account information is stored separately from the ambiguous transaction device or is encoded on a data storage device that is removable and can be ported to a new transaction device as desired. Thus, the network device is ambiguous because it can be used to conduct a transaction on behalf of any number of merchants without being permanently configured to initiate transactions only for specified merchant accounts.

In an exemplary embodiment, a method is provided for using a portable merchant account and an ambiguous transaction device to conduct a financial transaction. An acquirer receives an electronic financial transaction request from the ambiguous transaction device over a network. The transaction request includes merchant identifying information and transaction data. The transaction data includes a financial card number and an amount for the transaction.

The acquirer accesses a merchant account database having information representing multiple merchant accounts. In the merchant account database, each merchant account has merchant identifying information associated therewith. The transaction request is associated with one of the merchant accounts by comparing the merchant identifying information received in the transaction request with the merchant identifying information associated with each merchant account in the database. Each merchant account can also be linked to a merchant financial card where payments are credited.

The portable merchant accounts and ambiguous transaction devices of the invention overcome the excessive costs of existing financial transaction devices. The ambiguous devices of the invention use existing network devices to conduct financial transactions. For example, a cell phone, computer, personal digital assistant (“PDA”), or the like can be used as an ambiguous transaction device. Sales representatives or other individuals often own one or more of these network devices, thus saving the cost of purchasing point of sale terminals or other dedicated transaction devices.

Furthermore, network devices of the invention, including point of sale devices and Automatic Teller Machines (ATMs), can be provided for public use or shared among individuals. Since the merchant identifying information can be stored separately from the ambiguous transaction device, different persons acting as merchants can use the same publicly-accessible ambiguous transaction device by entering the merchant identifying information into the device.

The portable merchant account and ambiguous transaction device allow users to more easily carry out financial transactions. For instance, embodiments of the present invention allow a business establishment to receive payment for services, while allowing the service provider (e.g. a waiter or a beautician) to receive a tip on a financial card. The business establishment and the service provider can use the same ambiguous device to conduct both transactions and each will receive their corresponding payment in their portable merchant account. In another embodiment, multiple merchants sharing office space can use a single ambiguous device. Because the device is ambiguous, merchant occupancy can fluctuate and the ambiguous device does not need reprogramming. In yet another embodiment, multiple merchants at a convention can conduct transactions on a single ambiguous device of the present invention.

These and other features of the invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary method implementing an ambiguous transaction device and portable merchant account of the present invention;

FIG. 2 shows the ambiguous transaction device of FIG. 1 associated with a storage device;

FIG. 3 illustrates various aspects of the portable merchant account of FIG. 1;

FIG. 4 illustrates the association of a financial transaction with the portable merchant account of FIG. 1;

FIG. 5 illustrates an exemplary network employing the ambiguous device and portable merchant account of FIG. 1;

FIG. 6 shows an exemplary data stream for transmitting a financial transaction over the network of FIG. 4; and

FIG. 7 shows an exemplary external device attached to the ambiguous device of FIG. 4.

### DETAILED DESCRIPTION OF THE PREFERRED EMBODIMENTS

The present invention relates to electronic financial transactions conducted over a network. An electronic financial transaction typically begins when a payer owes a seller an amount of money in exchange for goods or services rendered and presents the seller with a financial card for payment. Upon execution of the transaction, the issuing bank, which issued the card, debits the buyer's financial card account and transfers funds to the acquirer bank. After settlement fees are deducted, payment is made to the acquirer bank, which credits the seller's account.

FIG. 1 shows an exemplary system for conducting a financial transaction according to the present invention. A payer 12 enters into an electronic financial transaction with merchant 14. An ambiguous transaction device 16 is configured to receive and send transaction requests 10 over a network. An acquirer bank 22 receives transaction request 10 from the network.

A processor 18 receives transaction 10 from ambiguous device 16 and routes it to an acquirer 22. Processor 18 maintains a route table 20 which processor 18 uses to determine the appropriate destination for electronic transaction 10. Using route table 20, processor 18 routes transaction 10 to acquirer 22 over the network.

Acquirer 22 maintains a merchant account database 24 having a plurality of merchant accounts. Merchant 14 has a merchant account 26 that is stored within database 24. Acquirer 22 also has means for communicating transaction request 10 for transaction processing 30. Issuer bank 32 receives transaction request 10 from acquirer 22 and either approves or declines the transaction. If transaction request 10 is approved, transaction request 10 is settled and funds are transferred from issuer 32 to acquirer 22. Acquirer 22 deposits the funds in merchant account 26. Merchant 26 has access to the finds through merchant financial card 28.

FIG. 1 illustrates a typical financial transaction with which the methods and ambiguous transaction devices of the invention can be practiced. However, the invention is not limited to the relationships between parties illustrated in FIG. 1 or any particular transaction so long as a party to an electronic financial transaction is capable of transmitting a transaction request using an ambiguous transaction device over a network to an entity that is capable of authorizing, executing, or otherwise facilitating the transaction.

Ambiguous transaction device 16 is a transaction device that connects to a network and can transmit a transaction. In an exemplary embodiment, ambiguous device 16 encodes merchant information at the time of the transaction. Ambiguous device 16 may be a personal digital assistant (PDA), a cell phone, a cell phone with short message servicing (SMS) capabilities, a networked computer, a point of sale terminal, or an automatic teller machine, and the like. In general, the ambiguous transaction devices of the invention have an input component that accesses transaction data as described herein, and a networking component, which transmits transaction requests over a network.

Ambiguous device 16 communicates with acquirer 22 over the network. The network may be any type of electronic network. Suitable networks include a Global System for Mobile communications (GSM) network, including General Packet Radio Service (GPRS) and Enhanced Data rate for GSM Evolution (EDGE) services, other cell phone networks such as a Code Division Multiple Access (CDMA) network, a public switched telephone network, or the Internet.

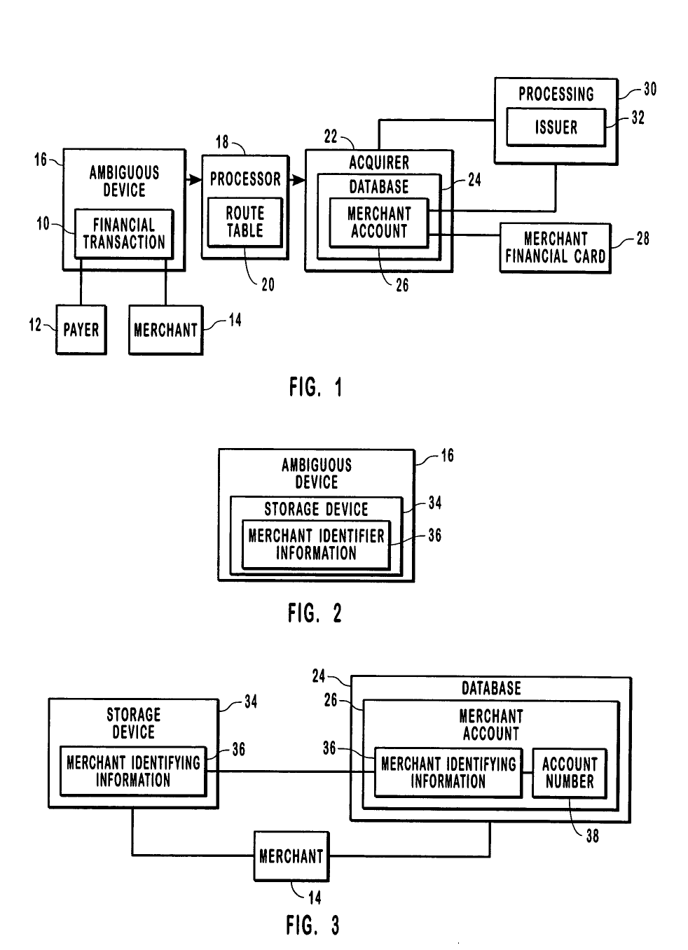

As shown in FIG. 2, ambiguous device 16 is configured to accept a storage device 34. Storage device 34 may be a card with a magnetic stripe, such as a financial card, a Subscriber Information Module (SIM) card, a smart card, or a radio frequency (RF) card. Ambiguous device 16 and storage device 34 are configured to operate together. For instance, a cell phone on a GSM network can use the SIM card. A point of sale terminal or an ATM may use the financial card, or the smart card. Any ambiguous device 16 can be configured to use any storage device 34. However, using a combination of an ambiguous device 16 and storage device 34 that is commercially available usually minimizes cost since it saves the expense of designing the ambiguous device 16 to work with the storage device 34.

Different means exist for operatively connecting storage device 34 to ambiguous device 16. For instance, the SIM card can connect to the cell phone by inserting it into a slot in the cell phone having a SIM card reader. The point of sale terminal may have a card swiper that reads the magnetic stripe on the back of the card. The PDA may have a wireless card reader that accepts credit cards and/or smart cards and communicates with the PDA over a specified radio frequency. The PDA may also have a click and point interface or an infrared interface. Generally, any connection means can be used to connect storage device 34 with ambiguous device 16 as circumstances require.

As shown in FIG. 2, storage device 34 has merchant identifying information 36 thereon. Merchant identifyng information 36 can be any unique name, number, or code that can be used to identify merchant 14. Merchant identifying information includes a SIM ID number, a telephone number, a merchant name, or a unique name or number assigned by acquirer 22. Merchant identifying information 36 may be encoded on the storage device 34 for the purpose of conducting financial transactions. For instance, account number 38 can be encoded on storage device 34 and transmitted over the network to acquirer 22 as merchant identifying information 36.

Alternatively, merchant identifying information 36 is a unique number or ID that is placed on the storage device for other purposes. For example, the merchant identifying information on a SIM card is a SIM ID number that is used to keep track of a telephone account that the merchant has with a cell phone provider. Although the SIM number has an independent use, it can be used to associate merchant account 24 with electronic financial transactions received from ambiguous device 16.

In one embodiment, ambiguous device 16 requires a storage device 34 that is operatively connected to ambiguous device 16. However, in another embodiment, ambiguous device 16 has volatile memory that erases after each transaction. In one embodiment, merchant identifying information 36 is transmitted to ambiguous device 16 on a per transaction basis or stored in memory for a predetermined period of time.

Ambiguous device 16 and/or storage device 34 may be owned or controlled by merchant 14. For instance, merchant 34, may own the cell phone and SIM card used to conduct the transaction request 10. In another embodiment, merchant 34 owns or controls only the storage device 34. In this situation, authorized use of the ambiguous device 16 may be temporary. For instance, storage device 34 may be a financial card and ambiguous device 16 may be an ATM open to the public.

The particular ambiguous device and storage device employed in a transaction generally depends on the type of transaction being carried out. In one embodiment of the present invention, the ambiguous device is configured to be used publicly or by multiple merchants and can process transactions from multiple merchants. For a publicly available ambiguous device, the storage device is removed after each transaction because the ambiguous device is shared among multiple merchants. In other words, the merchant account information is not retained by a public ambiguous device. Typically, merchant account information is stored temporarily. In one embodiment, the merchant account information used by the ambiguous device is only used for a single transaction. Thus, each merchant is required to provide their information (by swiping their card, for example) in order to process a transaction.

In a second scenario, the ambiguous transaction device is used privately. In this scenario the ambiguous device generally has additional uses (e.g. a GSM cell phone is used as an ambiguous device and for telephony. Where the ambiguous device is privately used, removing the storage device on a per transaction basis is less important. This type of ambiguous device is typically used by a single merchant.

FIG. 3 illustrates the relationship between merchant 14 and merchant account 26. Merchant 14 authorizes acquirer 22 to establish merchant account 26. Acquirer 22 gives merchant account 26 a number 38 and stores the account in the database 24 on acquirer's server. Merchant 14 provide acquirer 22 with merchant identifying information 36, which is stored on merchant's storage device 34. Merchant identifying information 36 is then associated with merchant account 26 such that merchant account 26 can be identified by merchant identifying information 36. Merchant identifying information may also be associated with multiple ambiguous devices.

Merchant 14 can provide the merchant identifying information 36 in several different ways depending on the type of ambiguous device 16 and storage device 34 being used. For instance, merchant 14 may initialize a merchant account 26 by sending a Short Messaging Service (SMS) message indicating the merchant desires to initialize merchant account 26. Upon receiving the SMS message, acquirer 22 detects the SIM ID number and associates it with merchant account 26. Alternatively, merchant 14 may directly provide acquirer 22 with merchant identifying information 36. In another embodiment, merchant identifying information 36 is a financial card number on a card issued by acquirer 22. In this case, acquirer 22 can associate the financial card number with merchant account 26 without input from merchant 14.

As mentioned above, merchant account 26 may also be linked to merchant financial card 28 (FIG. 1). Linking a merchant account to a financial card is described in U.S. patent application Ser. No. 10/358,751, filed Feb. 5, 2003, entitled “Linking a Merchant Account with a Financial Card,” which is incorporated herein by reference. Linking merchant account 26 to merchant financial card 28 allows merchant 14 to receive payment from payer 12 on merchant financial card 28. The card number on merchant financial card 28 may also be used as merchant identifying information 36. In one embodiment, merchant identifying information 36 and account number 38 are assigned the same number as merchant financial card 28. The foregoing patent application also includes further relevant details regarding the parties of FIG. 1 and their relationships. However, and noted above, the present invention can also be practiced in combination with financial systems and transactions other than those described in the foregoing patent application or in reference to FIG. 1.

A temporary merchant account can also be established when needed. For example, a temporary merchant account can be established while a merchant awaits approval of the financial account that is to be linked to the merchant account. The merchant receives an unbranded financial card which has merchant identifying information thereon. The merchant can use the card to receive payment but may not use the card to make payment. Embodiments of the present invention however, contemplate unbranded or temporary financial cards that can be used to both receive and make payment. Thus, a merchant can begin processing payments immediately after receiving a temporary card and an ambiguous device and the merchant is not required to wait for a merchant card in order to conduct business.

Upon approval of the merchant, the merchant is provided with a fully active merchant account such that the merchant can receive payment using the temporary or unbranded card. The merchant may or may not be assigned new merchant identifying information. One benefit of this method is that a new merchant can obtain a point of sale device that acts as an ambiguous transaction device, as well as a temporary merchant account, during an initial visit to a bank or other financial entity. No longer does a new merchant have to wait for several days or weeks to obtain the ability to accept payment using a point of sale device and a merchant account.

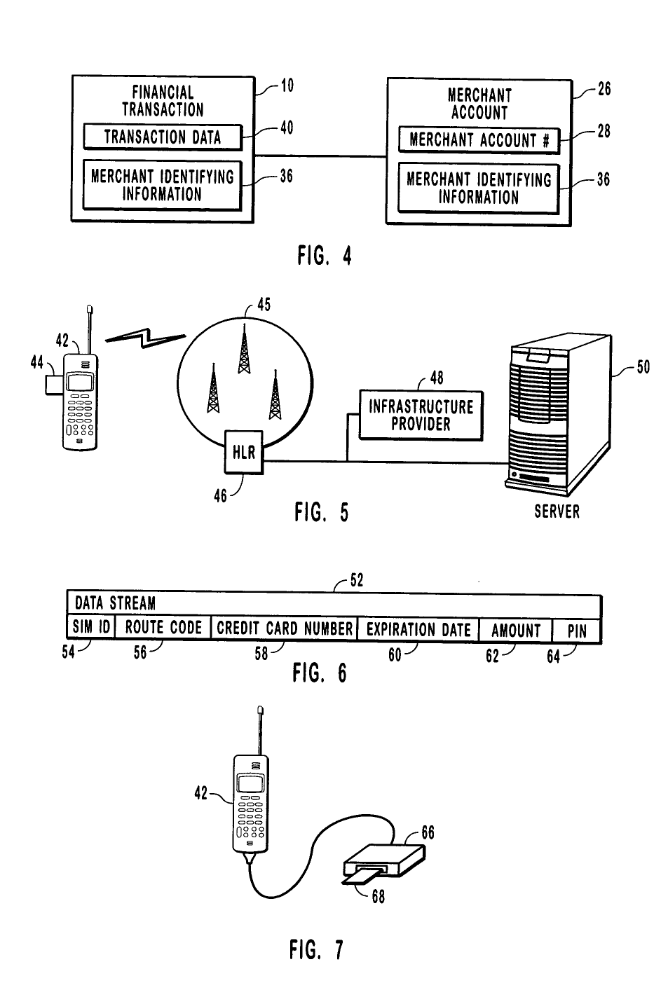

As mentioned above, ambiguous device 16 transmits financial transaction request 10 to acquirer 22. In FIG. 4, financial transaction request 10 includes transaction data 40 and merchant identifying information 36. Transaction data 40 includes information used to execute the requested financial transaction, such as a credit card number of payer 12 and an expiration date. Transaction data 40 also includes the amount to be debited to payer 12.

Transaction data 40 is stored separately from ambiguous device 16 and therefore is received by ambiguous device 16 on a per transaction basis. As used herein, the term “stored separately” refers to the transaction data being stored in a data storage device that is not integrally or permanently linked or associated with the transaction device or to the transaction data being stored in a manner that it can be conveniently ported from one transaction device to another as desired. By way of example, the term “stored separately” extends to the storage of transaction data on a magnetic strip of a financial card or the storage of the data on a SIM card or another transferable data storage or memory chip. Ambiguous device 16 can receive transaction data by various methods. For instance, ambiguous device may have a keypad by which data, such as a monetary amount for the transaction, request 10 can be keyed in. Typically, the transaction data includes a credit card number. The keypad can also be used to key in financial card numbers.

Alternatively, ambiguous device 16 may have an external device that encodes the financial card information and prepares it for transmission over the network. The external device may be a card reader and/or may be wireless. In one embodiment, the external device includes a Bluetooth wireless device. Furthermore, a card reader such as a card swiper may be incorporated directly on to ambiguous device 16.

The transaction system of the present invention enables an acquirer to associate transaction request 10 with merchant account 26. As mentioned above with reference to FIGS. 1 and 3, acquirer 22 receives a transaction request 10 from merchant 14. Acquirer 14 receives transaction data 40 and merchant identifying information 36 over the network. The transaction data includes an amount. Acquirer 22 accesses the plurality of accounts in database 24 and associates transaction request 10 with merchant account 26 by comparing merchant identifying information 36 received in transaction request 10 with merchant identifying information 36 associated with merchant account 26.

Acquirer 22 transmits transaction request 10 for processing and receives a response from issuer 32 as to whether or not transaction request 10 has been approved. Acquirer 22 sends a response over the network indicating whether transaction request 10 has been approved. If transaction request 10 is approved by issuer 32, acquirer 22 settles the transaction 10 with the issuer and deposits an amount owed, less settlement fees, in merchant account 26. Alternatively, settlement fees may be aggregated and paid periodically, such as at the end of the month. Merchant account 26 is linked to merchant financial card 28, which provides merchant 14 with access to funds in merchant account 26.

Similarly, the transaction system of the invention enables a merchant 14 to conduct financial transactions over the network. Merchant 14 authorizes acquirer 22 to establish merchant account 26 and to store merchant account 26 in database 24. In addition, acquirer 22 associates merchant identifying information 36 with merchant account 26 and links merchant account 26 to merchant financial card 28.

Merchant 14 enters into a transaction 10 with payer 12 and transmits transaction data 40 and merchant identifying information 36 over the network to acquirer 22. Acquirer 22 associates merchant account 26 with transaction request 10 by comparing merchant identifying information 36 received in transaction request 10 with merchant identifying information 36 associated with merchant account 26 in the database. Merchant 14 receives a response that indicates whether transaction request 10 has been authorized. Merchant 14 receives a monetary amount in merchant account 26 after issuer 32 and acquirer 22 settle transaction request 10. Merchant 14 has access to funds in merchant account 26 through merchant financial card 28, which is linked to merchant account 26.

FIG. 5 illustrates an exemplary embodiment of the invention in which transactions are conducted over a GSM network using a GSM terminal, such as a cellular telephone 42. Telephone 42 is an ambiguous transaction device capable of transmitting a transaction to acquirer 22. Telephone 42 includes a SIM card 44, which is a data storage device 34. The SIM card 44 contains a SIM ID number, which is a unique identifier that can operate as a merchant identifying information 36. Merchant 44 initializes merchant account 26 such that the SIM ID number is associated with merchant account 26 in the database of the acquirer. Once the SIM ID number is associated with account 26, merchant 16 can use SIM card 44 and telephone 42 to conduct electronic financial transactions over the GSM network.

An example of methods and data structures for routing transaction request 10 over the GSM network is described in reference to FIGS. 5 and 6. In this embodiment, the transaction data is encoded in a data structure 52 that is formatted according to the requirements of the GSM network. The routing of transaction request 10 is determined from route code 56 that has been entered by the party initiating the transaction. Infrastructure provider 48 provides acquirer 22 with route code 56, which can be used by any party who wishes to transmit a transaction request 10. Merchant 14 designates the destination of transaction request 10 using route code 56 in data structure 52. Transaction request 10 is transmitted from telephone 42 over radio waves to a cell phone tower 45 operated by a cell phone carrier. A home location register (HLR) 46 routes transaction request 10 to a desired destination using route code 56. Infrastructure provider 48 and acquirer 22 determine how transaction request 10 is transmitted to server 50. In one embodiment, HLR 46 forwards Unstructured Supplementary Service Data (USSD) data as an IP packet over the Internet. HLR 46 then waits for a response from server 50. Server 50 obtains authorization for transaction request 10 and sends a response to HLR 46, including a message indicating authorization. HLR 46 transmits the message to telephone 42. In one embodiment, HLR waits a predetermined time for a response from server 50. If the connection between HLR 46 and server 50 times out, server 50 prepares an SMS message that is transferred to HLR 46 as a store and forward message. HLR 46 transmits the store and forward message when telephone 42 is able to receive the message.

In another embodiment of the invention, HLR 46 routes data structure 52 to infrastructure provider 48. Infrastructure provider 48 communicates with acquirer 22 by dialing a number that connects infrastructure provider 48 with server 50. Infrastructure provider 48 then converts the transaction request to a dual-tone multi-frequency (DTMF) signal and streams the DTMF signal to server 50 over the telephone line.

In the exemplary embodiment shown in FIGS. 5 and 6, telephone 42 transmits transaction request 10 by generating a data structure according to the specifications of the unstructured supplementary service data parameters in the GSM protocol. In this embodiment, data structure 52 is a USSD message and includes a SIM ID 54, a route code 56, a credit card number 58, an expiration date 60, and an amount 62. SIM ID 54 may be in a different layer of data structure 52 than credit card number 58. SIM ID 54 may also be sent in data structure 52 without merchant 14 specifying that SIM ID 54 be sent. In one embodiment, data structure 52 also includes a PIN number 64, which acquirer 22 uses to verify the authenticity of transaction request 10.

HLR 46 and infrastructure provider 48 use route code 56 to route transaction request 10 to each other and to server 50. Acquirer 22 uses SIM ID number 54 to associate transaction request 10 with merchant account 26. Credit card number 58, expiration date 60, and amount 62 provide acquirer 22 with sufficient information to execute the requested financial transaction. As noted above, unauthorized use of merchant account 26 can be prevented by including the PIN 64.

In a typical GSM system, merchant 22 keys in transaction request 10 by pressing the star key “*”. In an exemplary string of keying, the USSD message includes “* route code 56 * credit card number 58 * expiration date 60 * amount 62 * PIN #”. In another embodiment, telephone 42 has an SMS message menu where a merchant can select a menu item that will at least partially prepare a USSD or SMS message.

FIG. 7 shows telephone 42 connected to an external device 66. External device 66 is configured to encode all or part of data structure 52. External device may connect to telephone 42 through a conductive wired interface, or external device 66 may form a wireless connection, such as a connection with a Bluetooth enabled device. External device 66 may be a card reader configured to read card 68, examples of which include smart cards, SIM cards and credit cards. External device 66 may have a card swiper for swiping financial cards with a magnetic stripe.

Using telephone 42 as an ambiguous transaction device allows merchant 14 to receive payment from a payer 12. Acquirer receives financial transaction request 10 in the form of a data structure 52. Data structure 52 is transmitted to server 50, such that acquirer 22 is capable of associating data structure 52 with merchant account 26 by comparing SIM ID 54 with the merchant identifying information associated with account 26. Acquirer 22 transmits the transaction data for processing and issuer 32 provides authorization. Upon settlement, an amount is added to merchant account 26, which is accessible to merchant 14 through, for example, merchant financial card 28.

In an alternative embodiment, merchant 14 engages in a transaction using the method of the present invention to provide payment from the merchant financial card 28 linked to merchant account 26. In this embodiment, merchant 14 uses cell telephone 42 to conduct transaction request 10. A different data structure is used to transmit the transaction data, including a telephone number of another GSM terminal. Upon receiving the request to make payment, SIM ID 54 is used to associate the transaction with merchant account 26. However, merchant account 26 is associated with transaction request 10 to identify financial card 28, which is debited in the transaction.

Acquirer 22 also associates the payee's telephone number with a payee account. In this particular embodiment, payee telephone numbers are associated with payee accounts in a manner similar to the association of merchant identifying information with merchant accounts as described herein. Acquirer 22 then associates the transaction to the payee account by comparing the transaction data 40 received with the associated telephone. In yet another embodiment, a menu item or key is provided on telephone 42 to enable the merchant 14 to select a payee, key in an amount, and press “send” to send an individual an amount.

If a payee does not have an account with acquirer 22, the acquirer can maintain the funds in a temporary account and notify the payee of the available funds. Acquirer 22 can then require that payee establish an account to receive the funds.

In one method of the present invention, acquirer 22 promotes its business by allowing registered payees to send money to other individuals and requiring the individuals to register to receive their funds. In another embodiment, acquirer 22 gives incentives to registered payees for promoting other individuals or business to register as a merchant.

In one embodiment of the present invention, a payee uses an ambiguous device to “push” an amount of money to the merchant account. In a conventional “pull” transaction, a merchant obtains a payee's credit card or other payment card and uses it to identify the payee using a point of sale device or another dedicated payment system. In contrast, the push transactions involve the merchant granting the payee access to the merchant account number by, for example, giving the customer temporary use of a merchant account card that can be used in a point of sale device or another ambiguous transaction device. This enables the payee to control the transaction. This method also provides security advantages, because the payee does not need to divulge the payee's account number associated with its financial card to a person who represents the merchant.

The portable merchant accounts of the invention can also be used to form clusters of portable merchant accounts accessing a single ambiguous device in a hub and spoke fashion. Each merchant of a plurality of merchants has a wireless external device. Each device is configured to transmit both merchant identifying information 36 and transaction data 40 to ambiguous device 16 over a wireless connection. Because merchant identifying information 36 is sent to ambiguous device 16 on a per transaction basis, only one ambiguous device 16 is needed for a plurality of merchants. This method is useful in retail establishments, such as shopping malls or department stores, where multiple merchants can share an ambiguous device 16.

Embodiments within the scope of the present invention also include computer readable media having executable instructions or data fields stored thereon. Such computer readable media can be any available media which can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions or data fields and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

Although not required, the invention can be described in the general context of computer-executable instructions, such as program modules, being executed by a computer. The invention can also be practiced using hardware-based systems and any combination of hardware and software. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An ambiguous transaction device for conducting a financial transaction for a merchant having a merchant account, the transaction device comprising:
an input component for receiving merchant identifying information that is stored separately from the ambiguous transaction device and transaction data; and
a networking component for transferring the transaction data and the merchant identifying information to an acquirer, wherein the merchant identifying information enables the acquirer to associate a merchant with the financial transaction and the transaction data enables the acquirer to execute the financial transaction.

2. The ambiguous transaction device of claim 1, wherein the ambiguous transaction device is incorporated into a point of sale device.

3. The ambiguous transaction device of claim 1, wherein the ambiguous transaction device is incorporated into an automatic teller machine.

4. The ambiguous transaction device of claim 1, wherein the transaction data comprises a financial card number.

5. The ambiguous transaction device of claim 4, wherein the financial card number is a credit card number.

6. The ambiguous transaction device of claim 1, wherein the merchant identifying information is stored in a magnetic stripe of a financial card that can be read by the ambiguous transaction device.

7. The ambiguous transaction device of claim 1, wherein the merchant identifying information is stored in a removable data storage device that can be received by the ambiguous transaction device.

8. The ambiguous transaction device of claim 6, wherein the merchant identifying information comprises at least one of a network ID, a telephone number, an IP address, or a transmission frequency.

9. A method for conducting an electronic financial transaction over a network using an ambiguous transaction device, the method comprising:
receiving a an electronic financial transaction request from the ambiguous transaction device over the network, the transaction request including merchant identifying information that is stored separately from the ambiguous transaction device and transaction data;
accessing a merchant account database having information specifying a plurality of merchant accounts, each of the plurality of merchant accounts having merchant identifying information associated therewith; and
associating the transaction with one of the plurality of merchant accounts by comparing the merchant identifying information received in the transaction request with the merchant identifying information associated with each of the plurality of merchant accounts in the merchant account database.

10. The method of claim 8, wherein the ambiguous transaction device receives the merchant identifying information and the transaction information on a per transaction basis.

11. The method of claim 8, wherein the merchant identifying information is stored separately on a transaction storage device and the ambiguous transaction device receives the merchant identifying information from the transaction storage device to generate the transaction request.

12. The method of claim 11, wherein the transaction storage device is a financial card.

13. The method of claim 11, wherein the transaction storage device is a SIM card.

14. The method of claim 11, wherein the transaction storage device is a smart card.

15. The method of claim 9, wherein the ambiguous transaction device is a cellular telephone.

16. The method of claim 9, wherein the ambiguous transaction device is a computer.

17. The method of claim 9, wherein the ambiguous transaction device is one of a point of sale terminal and an automatic teller machine.

18. The method of claim 9, wherein at least some of the transaction data is generated by the ambiguous transaction device upon selection of a menu item from a menu on the ambiguous device.

19. The method of claim 9, wherein the ambiguous device generates at least some of the transaction data by receiving said at least some of the transaction data from a card reader.

20. The method of claim 9, wherein the transaction data comprises a credit card number, a credit card expiration date, and an amount.

21. The method of claim 9, wherein a plurality of external devices communicate with the ambiguous device through a wireless connection, each of the external devices being capable of transmitting merchant identifying information and transaction data to the ambiguous device through the wireless connection.

22. A method for conducting a financial transaction over a network using an ambiguous transaction device, the method comprising:
authorizing the establishment of a merchant account linked to a financial card, wherein the merchant account is stored in a merchant account database and merchant identifying information is associated therewith;
sending a financial transaction request from the ambiguous transaction device over the network, the transaction request including merchant identifying information and transaction data, wherein the financial transaction to be executed is associated with the merchant account by comparing the merchant identifying information included in the transaction request with the merchant identifying information associated with the merchant account in the merchant account database, and wherein the transaction data enables the execution of the financial transaction;
receiving a transaction response that indicates that the transaction has been authorized.

23. The method of claim 22, wherein the ambiguous device generates at least some of the transaction data by receiving said at least some of the transaction data from a card reader.

24. The method of claim 24, wherein the ambiguous device generates at least some of the transaction data by receiving said at least some of the transaction data from an external device.

25. A method for receiving payment in a financial transaction conducted over a GSM network using a GSM terminal, the method comprising:
receiving a transaction request from a merchant from the GSM terminal over the GSM network, the transaction including merchant identifying information and transaction data, wherein the transaction request has been generated by the GSM terminal accessing a SIM card that stores the merchant identifying information;
accessing a merchant account database specifying a plurality of merchant accounts, each of the plurality of merchant accounts having unique merchant identifying information associated therewith;
associating the transaction request with one of the plurality of merchant accounts by comparing the merchant identifying information received in the transaction request with the unique merchant identifying information associated with each of the plurality of merchant accounts; and
transmitting transaction information for transaction processing, the transaction information including at least a portion of the transaction data, thereby enabling funds to be added to the associated merchant account.

26. The method of claim 25, wherein the GSM terminal is a cellular telephone.

27. The method of claim 25, wherein the financial transaction is a credit card transaction and the transaction data comprises a credit card number, a credit card expiration date, and an amount to be paid.

28. The method of claim 25, wherein the merchant identifying information is a SIM identification number.

29. A method of conducting an electronic financial transaction in a GSM network, the method comprising:
receiving a transaction request from a GSM terminal, the transaction request including a SIM identification number, a route code, a credit card number, a credit card expiration date, and an amount to be paid;
accessing a merchant account database specifying a plurality of merchant accounts, each of the plurality of merchant accounts being uniquely identified in the merchant account database using SIM identification numbers;
associating the transaction request with one of the plurality of merchant accounts by comparing the SIM identification number included in the transaction request with the SIM identification numbers identifying the merchant accounts in the merchant account database; and
sending an response that indicates the authorization of a financial transaction.

30. The method of claim 28, wherein the transaction request further includes a pin number.

31. The method of claim 29, wherein the transaction request is routed from a home location register to a server of an acquirer that participates in the electronic financial transaction.

32. The method of claim 29, wherein the transaction request is transmitted as unstructured service data.

33. The method of claim 29, wherein the GSM terminal has a menu and at least some of the transaction request is generated by the GSM terminal upon selection of a menu item.

34. The method of claim 29, wherein the SIM identification code included in the transaction request is generated by accessing the SIM identification code from a SIM card that is removably associated with the GSM terminal, such that the merchant is capable of generating transaction requests from multiple GSM terminals by porting the SIM card to any of said multiple GSM terminals.
